(19) United States
(12) Patent Application Publication
(10) Pub. No.: US 2026/0181048 A1
(43) Pub. Date: Jun. 25, 2026

(54) INFORMATION PROCESSING DEVICE

(71) Applicant: TOYOTA JIDOSHA KABUSHIKI KAISHA, Toyota-shi (JP)

(72) Inventors: Shingo SUGIMOTO, Nagoya-shi (JP); Yuma ITO, Chiryu-shi (JP); Shigeo OHNOGI, Aichi-gun (JP); Isao NISHIOKA, Tokyo (JP); Naoki UEDA, Nisshin-shi (JP)

(73) Assignee: TOYOTA JIDOSHA KABUSHIKI KAISHA, Toyota-shi (JP)

(21) Appl. No.: 19/366,915

(22) Filed: Oct. 23, 2025

(30) Foreign Application Priority Data
Dec. 20, 2024 (JP) 2024-225157

(51) Int. Cl. H04L 67/12; H04W 4/40

(52) U.S. Cl. CPC H04L 67/12; H04W 4/40

(57) ABSTRACT

The information processing device includes a communication unit that communicates with a vehicle, and a control unit, wherein the control unit monitors a state of the vehicle based on information received from the vehicle via the communication unit, and closes a communication line of the vehicle when it is determined that the vehicle is in a predetermined state.

### CROSS-REFERENCE TO RELATED APPLICATION

This application claims priority to Japanese Patent Application No. 2024-225157 filed on Dec. 20, 2024. The disclosure of the above-identified application, including the specification, drawings, and claims, is incorporated by reference herein in its entirety.

### BACKGROUND

### 1. Technical Field

The present disclosure relates to an information processing device.

### 2. Description of Related Art

Conventionally, there has been known a technique related to writing of information via a communication line. For example, Japanese Unexamined Patent Application Publication No. 2022-023707 (JP 2022-023707 A) discloses a communication device on which an eSIM (embedded Subscriber Identity Module) that allows writing a profile by way of a network using RSP (Remote SIM Provisioning) is mounted.

### SUMMARY

In recent years, use of a vehicle (connected car) equipped with an in-vehicle communication device has been expanding. In this vehicle, a profile of an eSIM mounted on the in-vehicle communication device can be remotely controlled (e.g., a communication line can be opened and blocked) by RSP. Typically, various functions of a vehicle based on communication can be used by opening a communication line at a timing such as when the vehicle is sold. In a state in which the communication line is opened, a maintenance cost such as a usage fee borne by the vehicle owner is required, for example. Therefore, it is preferable to block the communication line from the viewpoint of the maintenance cost when it is expected that the vehicle is not used for a relatively long period of time, for example.

An object of the present disclosure is to improve a technique of writing information via a communication line.

An aspect of the present disclosure provides an information processing device including
a communication unit that communicates with a vehicle, and a control unit, in which the control unit is configured to:
monitor a state of the vehicle based on information received from the vehicle via the communication unit; and
block a communication line of the vehicle when it is determined that the vehicle is in a predetermined state.

According to an aspect of the present disclosure, a technique of writing information via a communication line is improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram illustrating a schematic configuration of a system according to an embodiment of the present disclosure; and

FIG. 2 is a flowchart illustrating an operation of the information processing device.

### DETAILED DESCRIPTION OF EMBODIMENTS

### Summary of the Present Embodiment

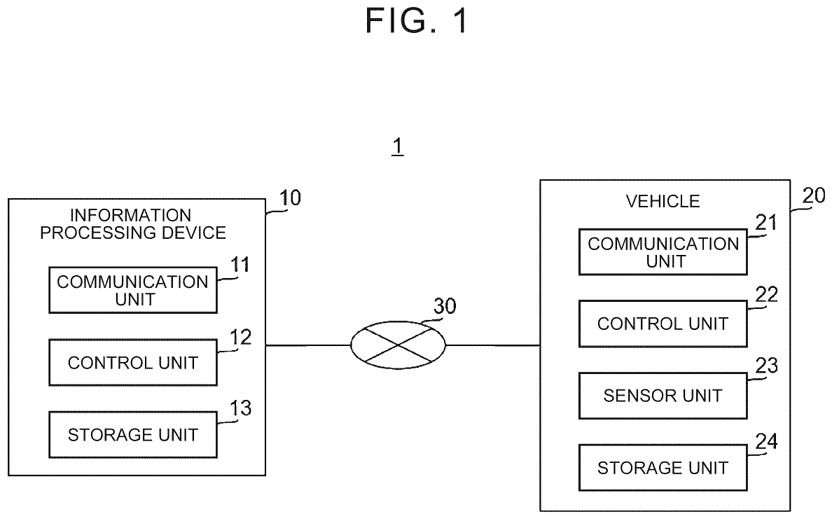

An outline of a system according to an embodiment of the present disclosure will be described with reference to FIG. 1. The system includes an information processing device 10 and a vehicle 20. The information processing device 10 and the vehicle 20 are communicably connected via a network 30 including the Internet or a mobile communication network.

The information processing device 10 includes one computer such as a server apparatus or a plurality of computers capable of communicating with each other. The information processing device 10 can automatically close the communication line of the vehicle 20 from a remote location using RSP. RSP is a mechanism for writing or changing a profile from a network to a SIM or the like.

Vehicle 20 includes any vehicle, such as an automobile. Vehicles 20 may include gasoline-powered vehicles, battery electric vehicle (BEV; Battery Electric Vehicle), hybrid electric vehicle (HEV; Hybrid Electric Vehicle). Vehicle 20 may also include a motor vehicle such as plug-in hybrid electric vehicle (PHEV; Plug-in Hybrid Electric Vehicle) or fuel cell electric vehicle (FCEV; Fuel Cell Electric Vehicle).

First, the outline of the present embodiment will be described, and the details will be described later. The information processing device 10 according to the present embodiment includes a communication unit 11 that communicates with the vehicle 20, and a control unit 12. The control unit 12 monitors the state of the vehicle 20 based on information received from the vehicle 20 via the communication unit 11. When determining that the vehicle 20 is in the predetermined state, the control unit 12 closes the communication line of the vehicle 20.

The information processing device 10 according to the present embodiment automatically closes the communication line when the vehicle 20 is in the predetermined state. Due to the blockage of the communication line, the maintenance cost of the communication line can be reduced.

### Configuration of the Information Processing Device 10

As illustrated in FIG. 1, the information processing device 10 includes a communication unit 11, a control unit 12, and a storage unit 13.

The communication unit 11 includes at least one communication interface connected to the network 30. The communication interfaces correspond to, for example, a mobile communication standard such as 5G (5th generation) or a wired LAN (Local Area Network) communication standard or a wireless LAN communication standard.

The control unit 12 includes one or more processors. The processor may be a general-purpose processor such as, for example, a CPU (Central Processing Unit), or a special-purpose processor specialized for a particular process. The control unit 12 executes processing related to the operation of the information processing device 10 while controlling each unit of the information processing device 10.

The storage unit 13 includes one or more memories. Each memory included in the storage unit 13 may function as, for example, a main storage device, an auxiliary storage device, or a cache memory. The storage unit 13 stores arbitrary information used for the operation of the information processing device 10. For example, the storage unit 13 may store, for example, a system program, an application program, and embedded software. The information stored in the storage unit 13 may be updated based on, for example, information acquired from the network 30 via the communication unit 11.

### Configuration of the Vehicle 20

As illustrated in FIG. 1, the vehicle 20 includes a communication unit 21, a control unit 22, a sensor unit 23, and a storage unit 24.

The communication unit 21 includes at least one communication interface connected to the network 30. The communication interfaces correspond to, for example, a mobile communication standard such as 4G or 5G, or a wired LAN communication standard or a wireless LAN communication standard, but are not limited thereto, and may correspond to any communication standard. In the present embodiment, the communication unit 21 is equipped with an eSIM (embedded Subscriber Identity Module) which is an embedded SIM (Subscriber Identity Module). eSIM can automatically perform rewriting of the profile, for example, opening and closing of a communication line, by using detection of a signal from the information processing device 10 via the network 30 as a trigger. Examples of the communication line include an in-vehicle network or an external network.

The control unit 22 includes one or more processors, one or more programmable circuits, one or more dedicated circuits, or a combination thereof. The processor is a general-purpose processor such as a CPU or a GPU, or a dedicated processor specialized for a specific process, for example. However, the processor is not limited to these. The programmable circuit is, for example, an FPGA, but is not limited to this. The dedicated circuit is, for example, an ASIC, but is not limited to this. The control unit 22 executes processing related to the operation of the terminal device while controlling each unit of the terminal device. The control unit 22 may function as a part of ECU (Electronic Control Unit).

The sensor unit 23 includes one or more sensors for detecting the state of the vehicle 20. The sensor unit 23 may include at least one of a position sensor, an acceleration sensor, a gyro sensor, a yaw rate sensor, an impact sensor, and an ignition sensor. The position sensor detects a position of the vehicle. The position sensors may include receivers corresponding to satellite-based positioning systems such as GPS (Global Positioning System). The ignition sensor detects that the ignition of the vehicle 20 is turned on or off. The acceleration sensor detects motion including vibration and vibration of the vehicle from acceleration of the vehicle. The gyro sensor senses motion, including shaking and vibration, of the vehicle from the angular velocity of the vehicle. The yaw rate sensor detects a motion including a shake and a vibration of the vehicle from a yaw rate of the vehicle. The impact sensor detects an impact applied to the vehicle, for example, based on an acceleration of the vehicle.

The storage unit 24 includes one or more memories. Each memory included in the storage unit 24 may function as, for example, a main storage device, an auxiliary storage device, or a cache memory. The storage unit 24 stores arbitrary information used for the operation of the information processing device 10. For example, the storage unit 24 may store a system program, an application program, and embedded software. In the present embodiment, the storage unit 24 stores setting information related to the vehicle 20. The configuration information may include, for example, information regarding settings of the owner driver and/or information regarding other vehicles 20 (e.g., used vehicles) having the same or similar specifications as the vehicle 20. The information stored in the storage unit 24 may be updated based on, for example, information acquired from the network 30 via the communication unit 21.

### Operation Flow of the Information Processing Device 10

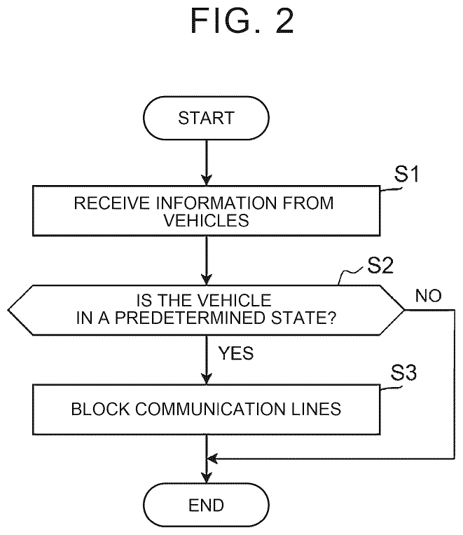

An operation of the information processing device 10 according to the present embodiment will be described with reference to FIG. 2.

S1: The control unit 12 of the information processing device 10 receives information from the vehicles 20 via the communication unit 11. In the present embodiment, the control unit 12 monitors the state of the vehicle 20 based on the information received from the vehicle 20 via the communication unit 11. The control unit 12 may monitor the state of the vehicle 20 based on the state information received from the position sensor, the acceleration sensor, or the ignition sensor of the vehicle 20, or the setting information of the vehicle 20 received from the storage unit 24 of the vehicle 20 via the communication unit 11.

The information may include information from the sensor unit 23 or the storage unit 24 of the vehicle 20. The information from the sensor unit 23 may include information regarding at least one of ignition, position, and acceleration of the vehicle 20. The information from the storage unit 24 may include information related to the setting of the vehicle 20.

S2: The control unit 12 determines whether or not the vehicle 20 is in a predetermined condition. When it is in a predetermined condition (S2-YES), the processing proceeds to S3. When not (S2-NO), processing ends.

The predetermined state is, for example, any state in which the vehicle 20 is expected not to be used for a relatively long period of time by an end user such as a vehicle owner. The predetermined state may include at least one of a transportation state in which the vehicle 20 is transported, an inventory state in which the vehicle 20 is held by a dealer or a used vehicle dealer, an exhausted vehicle state in which the vehicle 20 is exhausted, and an exhausted state in which the vehicle 20 is left for a long period of time. The determination of whether or not the vehicle 20 is in the transportation state may be performed based on information about the ignition, position, and/or vibration of the vehicle 20. For example, the control unit 12 may detect the shake of the vehicle 20 from the acceleration information, the angular velocity information, or the yaw rate information of the vehicle 20 while the ignition is off. Alternatively, the control unit 12 may detect the movement of the vehicle 20 from the position information of the vehicle 20 in a state where the ignition is off. In these cases, it may be determined that the vehicle 20 is in a transport state (being transported by a transport vessel or a transport vehicle). The determination of whether or not the vehicle 20 is in an inventory state may be performed based on the information on the setting of the owner driver of the vehicle 20. For example, when it is detected from the setting information of the vehicle 20 that the owner driver is not set, the control unit 12 may determine that the vehicle 20 is in an inventory state in the dealer. When it is detected from the setting information of the vehicle 20 that the owner driver setting has been deleted, the control unit 12 may determine that the vehicle 20 is in the stock state of the used business operator. The determination as to whether or not the vehicle 20 is in the waste vehicle state may be performed based on the information on the impact of the vehicle 20. For example, in a case where an impact due to a collision, that is, a sudden change in acceleration, angular velocity, or yaw rate is detected from acceleration information, angular velocity information, yaw rate information, or impact information of the vehicle 20, the control unit 12 may determine that the vehicle 20 is in a waste vehicle state. The determination as to whether or not the vehicle 20 is in an unattended state may be performed based on information about the ignition, the position, and/or the vibration of the vehicle 20. For example, in a case where the ignition is turned off or a state in which the position, acceleration, angular velocity, or yaw rate of the vehicle 20 does not change continues for a predetermined period of time (for example, one month), the control unit 12 may determine that the vehicle 20 is in an unattended state.

S3: The control unit 12 closes the communication line of the vehicle 20.

The information processing device 10 according to the present embodiment automatically closes the communication line when the vehicle 20 is in the predetermined state. Due to the blockage of the communication line, the maintenance cost of the communication line can be reduced. In the present embodiment, a RSP is used to block a communication line.

Blocking the communication line may include transitioning the communication line to a first occluded state or a second occluded state. In the first closed condition, the control unit 12 temporarily disables (deactivate) the communication line. In the second closed condition, the control unit 12 terminates the communication line. In the first closed state, the vehicle owner does not need to pay the usage fee, while the vehicle manufacturer needs to pay the radio usage fee and the universal service fee. Radio usage fees or universal service fees are, for example, from several yen to several tens of yen per month in Japan. Further, in the first closed state, no additional cost is required when returning the communication line from the first closed state to the open state. In the second closed state, the vehicle owner does not need to pay the usage fee, and the vehicle manufacturer does not need to pay the radio usage fee and the universal service fee. On the other hand, in the second closed state, an additional cost is required when returning the communication line from the second closed state to the open state. The additional cost is, for example, about several hundred yen to 1,000 yen in Japan. Alternatively, closing the communication line, the communication line, the first closing state, the second closing state, the third closing state, may be congested to shift to any of the fourth closing state and the fifth closing state. In the third closed state, the control unit 12 shifts the communication line to the dormant state (inactive). In the fourth closed state, the control unit 12 shifts the communication line to the pending state (pending). In the fifth closed state, the control unit 12 causes the communication line to transition to the use interrupted or stopped state (suspended).

When the communication line transitions to the first closed state, the control unit 12 may transmit a request for payment of the radio wave usage fee and the universal service usage fee to the vehicle manufacturer. When receiving a request to open the communication line from the vehicle owner, the control unit 12 may return the communication line to the open state. When the communication line has shifted to the second closed state, the control unit 12 may transmit information indicating that the communication line has shifted to the second closed state and that an additional cost is necessary for returning the communication line from the second closed state to the open state to the vehicle owner. The control unit 12 may return the communication line to the open state when the information certifying that the payment of the additional cost has been completed is received from the vehicle owner.

The control unit 12 may determine whether to shift the communication line to the first closed state or the second closed state based on the predetermined state. Transportation of the vehicle ends in a relatively short period of time (e.g., about 50 days). Therefore, when it is determined that the vehicle 20 is in the transportation state, the control unit 12 may shift the communication line to the first closed state. The inventory period of the vehicle at the dealer is relatively short (e.g., about three months). Therefore, when it is determined that the vehicle 20 is in an inventory state in the dealer, the control unit 12 may shift the communication line to the first closed state. The inventory period of a vehicle in a used business operator is a relatively long period (for example, several years). Therefore, when it is determined that the vehicle 20 is in the stock state of the used operator, the control unit 12 may shift the communication line to the first closed state. Alternatively, when it is determined that the vehicle 20 is in the stock state of the used business operator, the control unit 12 may perform control as follows. That is, the control unit 12 may shift the communication line to the first closed state when the period from the deletion of the owner driver setting of the vehicle 20 to the present is less than the predetermined threshold. When the period is equal to or greater than the predetermined threshold value, the communication line may be shifted to the second closed state. The predetermined threshold may be, for example, an average inventory period of other used vehicles having the same or similar specifications as the vehicle 20. When the vehicle is scrapped, it is expected that the vehicle will not be used for an extended period of time or permanently. Therefore, in a case where it is determined that the vehicle 20 is in the no-vehicle state, the control unit 12 may shift the communication line to the second closed state. When the vehicle is left unattended for an extended period of time, the vehicle may not be utilized thereafter. Therefore, when it is determined that the vehicle 20 is in the left state, the control unit 12 may shift the communication line to the second closed state. In summary, the control unit 12 may determine whether to shift the communication line to the first closed state or the second closed state based on the unused period of the vehicle 20 expected from the state of the vehicle 20. It should be noted that the criterion for the above determination is merely an example, and is not limited to these examples.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided. For example, in the above-described embodiment, the configuration and operation of the information processing device 10 may be distributed among a plurality of computers capable of communicating with each other.

What is claimed is:

1. An information processing device comprising
a communication unit that communicates with a vehicle, and a control unit, wherein
the control unit is configured to:
monitor a state of the vehicle based on vehicle state information received from at least one of a position sensor, an acceleration sensor, a gyro sensor, a yaw rate sensor, an impact sensor, and an ignition sensor of the vehicle via the communication unit, or vehicle setting information received from a storage unit of the vehicle; and
block a communication line of the vehicle when it is determined that the vehicle is in a predetermined state.

2. An information processing device comprising
a communication unit that communicates with a vehicle, and a control unit, wherein
the control unit is configured to:
monitor a state of the vehicle based on information received from the vehicle via the communication unit; and
block a communication line of the vehicle when it is determined that the vehicle is in a predetermined state.

3. The information processing device according to claim 2, wherein the predetermined state includes at least one of a transported state in which the vehicle is being transported, an in-stock state in which the vehicle is possessed by a dealer or a used car dealer, a deregistered state in which the vehicle is deregistered, and an abandoned state in which the vehicle is abandoned for a long period of time.

4. The information processing device according to claim 3, wherein:
the information includes information about at least one of ignition, position, and sway and vibration of the vehicle; and
a determination as to whether the vehicle is in the transported state and a determination as to whether the vehicle is in the abandoned state are executed based on the information about the at least one of ignition, position, and sway and vibration of the vehicle.

5. The information processing device according to claim 3, wherein:
the information includes information about settings of an owner driver of the vehicle; and
a determination as to whether the vehicle is in the in-stock state is executed based on the information about the settings of the owner driver of the vehicle.

6. The information processing device according to claim 3, wherein:
the information includes information about an impact of the vehicle;
a determination as to whether the vehicle is in the deregistered state is executed based on the information about the impact of the vehicle.
